(19) United States
(12) Patent Application Publication
(10) Pub. No.: US 2002/0059610 A1
(43) Pub. Date: May 16, 2002

(54) Interactive television application with watch lists

(76) Inventor: Michael D. Ellis, Boulder, CO (US)

Correspondence Address: FISH & NEAVE, 1251 AVENUE OF THE AMERICAS, 50TH FLOOR, NEW YORK, NY, 10020-1105, US

(21) Appl. No.: 09/864,558

(22) Filed: May 23, 2001

Related U.S. Application Data
(60) Provisional application No. 60/206,384, filed on May 23, 2000.

(51) Int. Cl. G06F 3/00

(52) U.S. Cl. 725/58

(57) ABSTRACT

An interactive television application with watch lists is provided. The user may add programs such as television programs, Internet web pages, e-commerce applications, e-mail applications, and music channels, to a watch list. The user may also select a program from the watch list to watch it or to perform some other function related to that program. The interactive television application may display, under user control, watch lists that are overlaid over television programming, scaled so as not to obscure television programming, or on touch-screen remote controls. Programs may be added by the user to the watch lists at any time, or may be automatically added or removed by the interactive television application based on user preference profiles and reminder lists.

This application claims the benefit of provisional application No. 60/206,384, filed May 23, 2000, which is hereby incorporated by reference herein in its entirety.

### BACKGROUND OF THE INVENTION

This invention relates to an interactive television application, and more particularly, to an interactive television application that includes watch lists.

Cable, satellite, and broadcast television systems provide users with a large number of television channels. Users have traditionally consulted printed television program schedules to determine broadcast times for television programs. More recently, interactive television program guides have been developed that allow television program information to be displayed on a user's television. Interactive television program guides, which are typically implemented on set-top boxes, allow the user to navigate through television program listings using a remote control.

With the increase in the number of available television channels, interactive television applications have been developed to provide the user with the ability to set reminders for television programs. An interactive television application that provides the user with the ability to set reminders for television programs is described in commonly-assigned Knudson et al. U.S. patent application Ser. No. 09/357,941, filed Jul. 16, 1999, which is hereby incorporated by reference herein in its entirety. Programs that are displayable on televisions are not, however, limited to traditional television programs. Programs may include other types of programs such as Internet Web pages, music channels and the like. In addition, users may be interested in switching back and forth between various television programs and other types of programs.

It would be desirable to provide the user with the ability to set reminders for different types of programs.

It would also be desirable to provide the user with the ability to easily manage the different types of programs.

### SUMMARY OF THE INVENTION

Therefore, it is an object of the present invention to provide the user with the ability to set reminders for different types of programs.

It is also an object of the present invention to provide the user with the ability to easily manage the different types of programs.

In accordance with the principles of the present invention, a user may set reminders for programs that are displayable on a display device by adding programs to a watch list. Preferred programs based on user preference profiles may also be added to the watch list automatically by the interactive television application.

Watch lists may be created by the user, through user interaction with display screens provided by the interactive television application. Watch lists may be displayed in response to user input or automatically by the interactive television application. In addition, the user may tune to different programs by selecting appropriate options on the watch lists. The interactive television application may provide the user with the ability to leave and return to a program in the same state.

Watch lists may be displayed on the display device as an overlay over other displayed programs, or without an overlay if the other displayed programs are reduced in size. In combination with on-screen watch lists, the watch lists may also be displayed on a touch-screen remote control. With a touch-screen remote control, the user can touch the remote control in order to navigate watch list options.

Further features of the invention, its nature and various advantages will be more apparent from the accompanying drawings and the following detailed description of the preferred embodiments.

### BRIEF DESCRIPTION OF THE DRAWINGS

FIG. 1 is a schematic block diagram of an illustrative system in accordance with the present invention.

FIGS. 2A-2D show illustrative arrangements for the interactive application equipment of FIG. 1 in accordance with the principles of the present invention.

FIG. 3 is an illustrative schematic block diagram of user television equipment of FIGS. 2A-2D in accordance with the principles of the present invention.

FIG. 4 is a generalized schematic block diagram of portions of the illustrative user television equipment of FIG. 3 in accordance with the principles of the present invention.

FIGS. 5-7B show illustrative display screens of program listings screens provided by an interactive television application in accordance with the principles of the present invention.

FIGS. 8-11 show illustrative display screens of program information screens that provide watch list functionality in accordance with the principles of the present invention.

FIG. 12 is an illustrative flow diagram of a process for automatically adding programs to a watch list based on user preference profiles, in accordance with the principles of the present invention.

FIGS. 13-17 show illustrative display screens that include displays of watch lists and user selectable options associated with programs on watch lists in accordance with the principles of the present invention.

FIG. 18-19 show an illustrative touch-screen remote control that includes displays of watch lists in accordance with principles of the present invention.

FIG. 20 shows illustrative display screen that includes a prompt for pausing a program in accordance with the principles of the present invention.

### DETAILED DESCRIPTION OF THE INVENTION

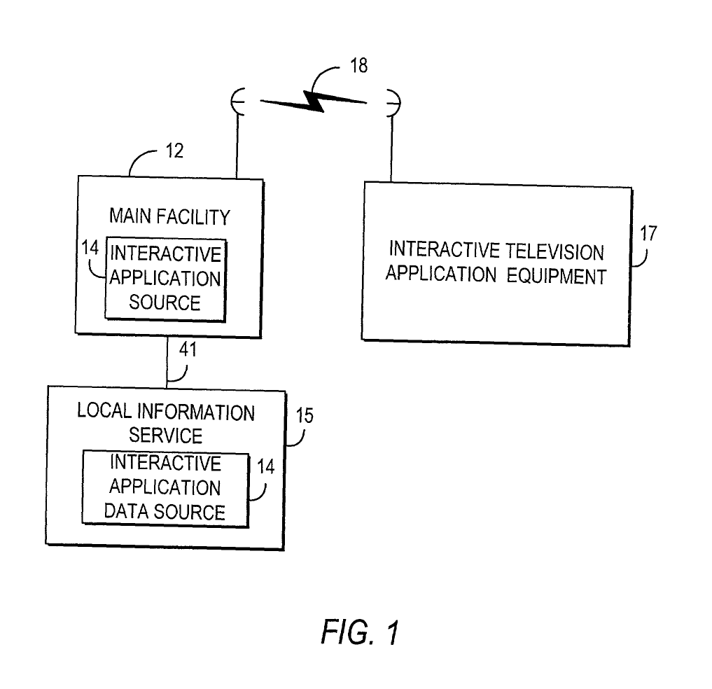

Illustrative system 10 in accordance with the principles of the present invention is shown in FIG. 1. Main facility 12 provides interactive television application data from interactive television application data source 14 to interactive television application equipment 17 via communications link 18. There may be multiple interactive television application data sources but only one has been shown in order to avoid adding complexity to FIG. 1. If desired, interactive television application data sources may be located at facilities separate from main facility 12, such as at local information service facility 15, and have their data provided to main facility 12 for localization and distribution. Data sources such as data source 14 may be any suitable computer or computer based system for obtaining data (e.g., manually from an operator, electronically via a computer network or other connection, or via storage media) and putting the data into electronic form for distribution by main facility 12. Link 18 may be a satellite link, a telephone network link, a cable or fiber optic link, a microwave link, an Internet link, a combination of such links, or any other suitable communications link. Video signals may also be transmitted over link 18 if desired.

Local information service facility 15 may be any suitable facility for obtaining data particular to a localized region and providing the data to main facility 12 over communications link 41. Local information source 41 may be, for example, a local weather station that measures weather data, a local newspaper that obtains local high school and college sporting information, or any other suitable provider of information. Local information service facility 15 may be a local business with a computer for providing main facility 12 with, for example, local ski reports, fishing conditions, menus, etc., or any other suitable provider of information. Link 41 may be a satellite link, a telephone network link, a cable or fiber optic link, a microwave link, an Internet link, a combination of such links, or any other suitable communications link.

The interactive television application data transmitted by main facility 12 to interactive television application equipment 17 may include television programming data (e.g., program identifiers, times, channels, titles, and descriptions), interactive advertisement data, help text data, pay-per-view data, weather data, sports data, music channel data, video-on-demand (VOD) data, near video-on-demand (NVOD) data, digital audio data, Internet Web data, games, etc. There are preferably numerous pieces or installations of interactive television application equipment 17, although only one is shown in FIG. 1 to avoid over-complicating the drawing.

Interactive television application data may be transmitted by main facility 12 to interactive television application equipment 17 using any suitable approach. Data files may, for example, be encapsulated as objects and transmitted using a suitable Internet based addressing scheme and protocol stack (e.g., a stack which uses the user datagram protocol (UDP) and Internet protocol (IP)). Systems in which interactive television application data is transmitted from a main facility to television distribution facilities are described, for example, in commonly-assigned Gollahon et al. U.S. patent application Ser. No. 09/332,624, filed Jun. 11, 1999, which is hereby incorporated by reference herein in its entirety.

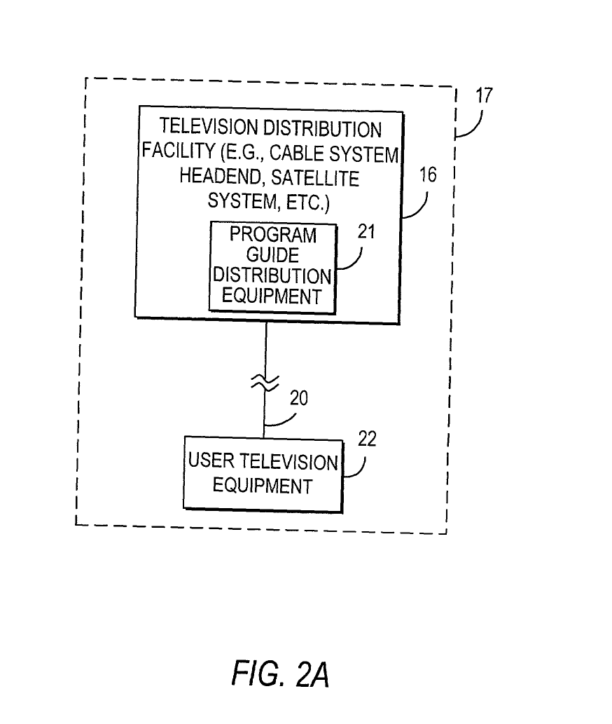

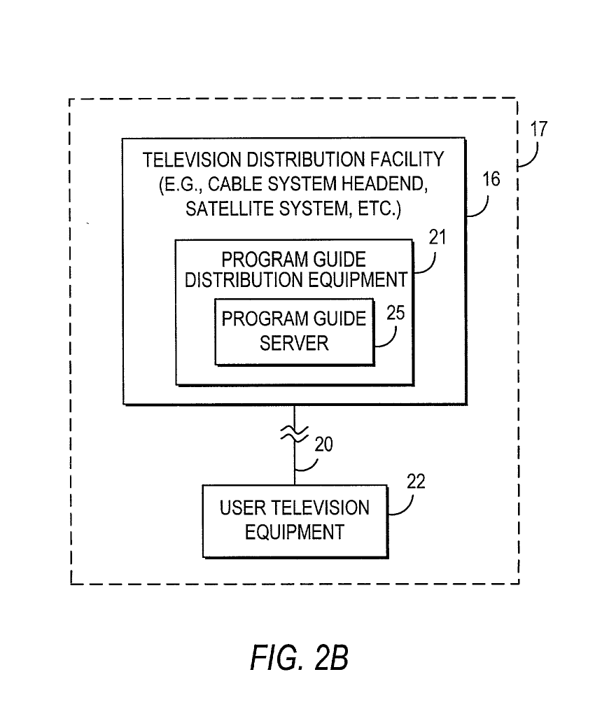

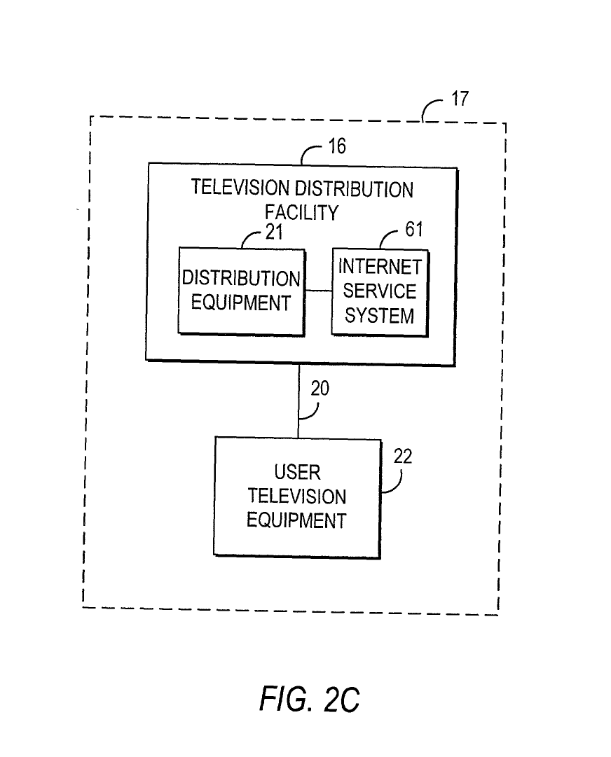

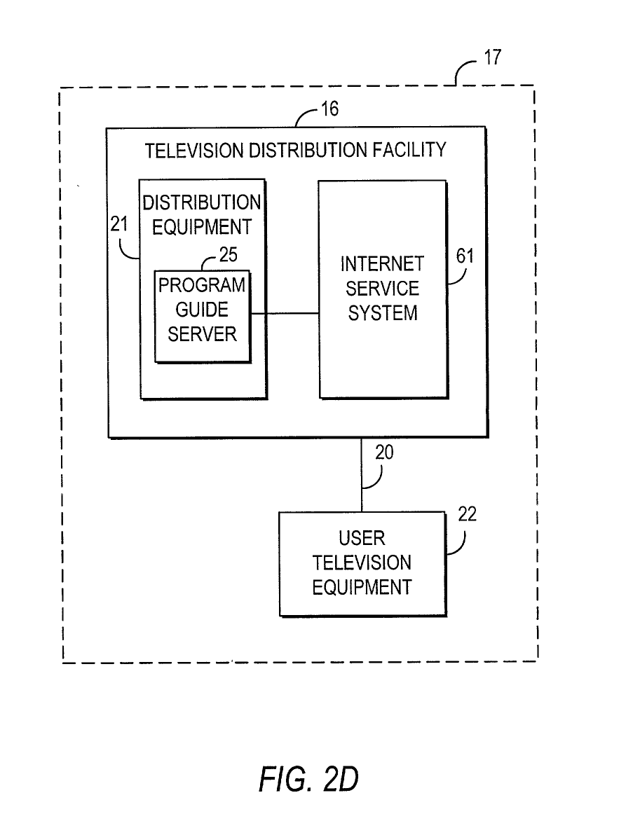

An interactive television application may be implemented on interactive television application equipment 17. Four suitable arrangements for interactive television application equipment 17 are shown in FIGS. 2A-2D. As shown, interactive television application equipment 17 may include application distribution equipment 21 located at television distribution facility 16, and user television equipment 22. The illustrations shown in FIGS. 2A-2D are merely illustrative. For example, television distribution facilities may not necessarily be part of interactive television application equipment 17.

The interactive television application may be implemented on user television equipment 22 as shown in FIGS. 2A and 2C, or may be implemented partially on user television equipment 22 and partially on interactive television application equipment 17 using a suitable client-server or distributed processing approach as shown in FIGS. 2B and 2D. Television distribution facility 16 may be any suitable distribution facility (e.g., a cable system headend, a broadcast distribution facility, a satellite television distribution facility, or any other suitable type of television distribution facility). Television distribution facility 16 may include distribution equipment 21.

Distribution equipment 21 of FIGS. 2A, 2B, 2C, and 2D may be any equipment suitable for providing interactive television application data to user television equipment 22 over communications path 20. Distribution equipment 21 may include, for example, suitable transmission hardware for distributing interactive television application data on a television channel sideband, in the vertical blanking interval of a television channel, using an in-band digital signal, using an out-of-band digital signal, or by any other suitable data transmission technique. Analog or digital video signals may also be distributed by distribution equipment 21 to user television equipment 22 over communications paths 20 on one or more television channels.

Communications paths 20 may be communications paths that are suitable for distributing interactive television application data. Communications paths 20 may include, for example, a satellite link, a telephone network link, a cable or fiber optic link, a microwave link, an Internet link, a data-over-cable service interface specification (DOCSIS) link, a combination of such links, or any other suitable communications link. Communications paths 20 preferably have sufficient bandwidth to allow television distribution facility 16 to distribute television programming to user television equipment 22. There are typically multiple pieces of user television equipment 22 and multiple associated communications paths 20, although only one piece of user television equipment 22 and communications path 20 are shown in FIGS. 2A-2D to avoid over complicating the drawings. If desired, television programming may be provided over separate communications paths (not shown).

FIG. 2B shows an arrangement for interactive television application equipment 17 in a client-server based or distributed interactive application system. As shown in FIG. 2B, distribution equipment 21 may include interactive television application server 25. Interactive television application server 25 may be any suitable software, hardware, or combination thereof for providing a client-server based interactive television application. Interactive television application server 25 may, for example, run a suitable database engine (e.g., SQL Server by Microsoft) and provide interactive television application data in response to queries generated by an interactive television application client implemented on user television equipment 22. If desired, interactive television application server 25 may be located at main facility 12 or other suitable location (not shown).

The interactive television application may retrieve interactive television application data from interactive television application server 25 using any suitable client-server based approach. The interactive television application may, for example, pass SQL requests as messages to interactive television application server 25. In another suitable approach, the interactive television application may invoke remote procedures that reside on interactive television application server 25 using one or more remote procedure calls. Interactive television application server 25 may execute SQL statements for such invoked remote procedures. In still another suitable approach, client objects executed by the interactive television application may communicate with server objects executed by interactive television application server 25 using, for example, an object request broker (ORB). This may involve using, for example, Microsoft's Distributed Component Object Model (DCOM) approach.

The interactive television application may communicate with interactive television application server 25 or Internet service system 61 over communications path 20 using any suitable network and transport layer protocols, if desired. A protocol stack may be used which includes, for example, Sequenced Packet Exchange/Internetwork Packet Exchange (SPX/IPX) layers, Transmission Control Protocol/Internet Protocol (TCP/IP) layers, AppleTalk Transaction Protocol/Datagram Delivery Protocol (ATP/DDP) layers, or any other suitable network and transport layer protocols. If desired, DOCSIS may also be used.

FIGS. 2C and 2D show Internet based interactive television application systems. Television distribution facility 16 may, for example, include Internet service system 61. Internet service system 61 may use any suitable combination of hardware and software capable of providing interactive television application data to the guide using an Internet based approach (e.g., the HyperText Transfer Protocol (HTTP)). If desired, Internet service system 61 may be located at a facility that is separate from interactive television application distribution facility 16.

If the interactive television application is implemented on user television equipment 22 of interactive television application equipment 17 as shown in FIG. 2C, Internet service system 61 (or other suitable equipment at interactive television application distribution facility 16 that is connected to Internet service system 61) may provide interactive television application data to user television equipment 22 via the Internet, or via interactive television application distribution equipment 21 using any suitable Internet-based approach (e.g., using the HyperText Transfer Protocol (HTTP) or File Transfer Protocol (FTP) over a Transmission Control Protocol/Internet Protocol (TCP/IP) type link). If the interactive television application implemented on interactive television application equipment 17 is a client-server guide as shown in FIG. 2D, interactive television application server 25 may obtain interactive television application data from Internet service system 61. The interactive television application may also, however, obtain interactive television application data from Internet service system 61 via an Internet connection.

In still another embodiment, distribution equipment 21 may include suitable hardware (not shown) on which a first portion or version of the interactive television application is implemented. A second portion or version of the interactive television application may be implemented on user television equipment 22. The two versions or portions of the interactive television application may communicate using any suitable peer-to-peer communications scheme (e.g., messaging, remote procedure calls, etc.) and perform interactive television application functions distributively between television distribution facility 16 and user television equipment 22.

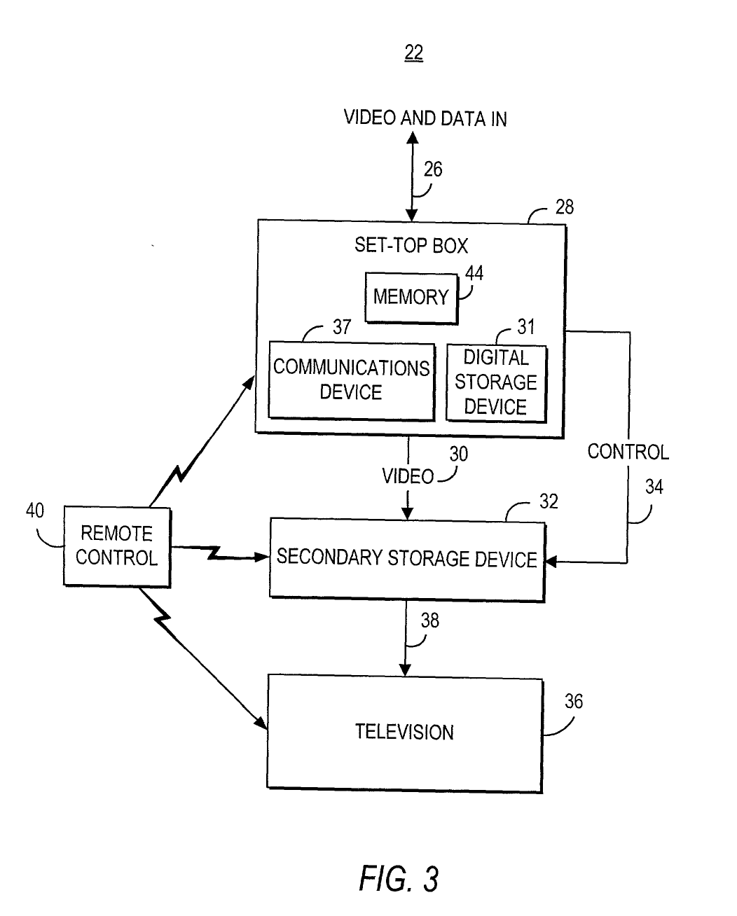

An arrangement for user television equipment 22 is shown in FIG. 3. User television equipment 22 of FIG. 3 receives video or a digital video stream and data from television distribution facility 16 (FIG. 1) at input 26. During normal television viewing, a user tunes set-top box 28 to a desired television channel. The signal for that television channel is then provided at video output 30. The signal supplied at output 30 is typically either a radio-frequency (RF) signal on a predefined channel (e.g., channel 3 or 4), or an analog demodulated video signal, but may also be a digital signal provided to television 36 on an appropriate digital bus (e.g., a bus using the Institute of Electrical and Electronics Engineers (IEEE) 1394 standard, (not shown)). The video signal at output 30 is received by optional secondary storage device 32.

The interactive television application may run on set-top box 28, on television 36 (if television 36 has suitable processing circuitry and memory), on a suitable analog or digital receiver connected to television 36, or on digital storage device 31 if digital storage device 31 has suitable processing circuitry and memory. The interactive television application may also run cooperatively on a suitable combination of these devices. Interactive television application systems in which a cooperative interactive television application runs on multiple devices are described, for example, in commonly-assigned Ellis U.S. patent application Ser. No. 09/186,598, filed Nov. 5, 1998, which is hereby incorporated by reference herein in its entirety.

Secondary storage device 32 can be any suitable type of analog or digital program storage device or player (e.g., a videocassette recorder, a digital versatile disc (DVD) player, digital video recorder, etc.). Program recording and other options may be controlled by set-top box 28 using control path 34. If secondary storage device 32 is a videocassette recorder, for example, a typical control path 34 involves the use of an infrared transmitter coupled to the infrared receiver in the videocassette recorder that normally accepts commands from a remote control such as remote control 40. Remote control 40 may be used to control set-top box 28, secondary storage device 32, and television 36.

If desired, a user may record programs, interactive television application data, or a combination thereof in digital form on optional digital storage device 31. Digital storage device 31 may be a writeable optical storage device (such as a DVD player capable of handling recordable DVD discs), a magnetic storage device (such as a disk drive or digital tape), or any other digital storage device. Interactive television systems that have digital storage devices are described, for example, in commonly-assigned Hassell et al. U.S. patent application Ser. No. 09/157,256, filed Sep. 17, 1998, which is hereby incorporated by reference herein in its entirety.

Digital storage device 31 may be located within set-top box 28 or external to set-top box 28. If digital storage device 31 is external to set-top box 28, digital storage device 31 may be connected to set-top box 28 via an output port and an appropriate interface.

In one suitable approach, processing circuitry in set-top box 28 may format the received video, audio and data signals into a digital file format. The digital file format may, for example, be an open file format such as the Moving Picture Experts Group (MPEG) MPEG-2 standard or the Moving Joint Photographic Experts Group (MJPEG) standard. The resulting digital data may be streamed to digital storage device 31 via an appropriate bus (e.g., a bus using the Institute Electrical and Electronics Engineers (IEEE) 1394 standard), and stored on digital storage device 31. In another suitable approach, an MPEG-2 data stream or a series of files may be received from distribution equipment 21 and stored.

Television 36 receives video signals from secondary storage device 32 via communications path 38. The video signals on communications path 38 may either be generated by secondary storage device 32 when playing back a prerecorded storage medium (e.g., a videocassette or a recordable digital video disc), by digital storage device 31 when playing back a pre-recorded digital medium, may be passed through from set-top box 28, may be provided directly to television 36 from set-top box 28 if secondary storage device 32 is not included in user television equipment 22, or may be received directly by television 36. During normal television viewing, the video signals provided to television 36 correspond to the desired channel to which a user has tuned with set-top box 28. Video signals may also be provided to television 36 by set-top box 28 when set-top box 28 is used to play back information stored on digital storage device 31.

Set-top box 28 may contain memory 44. Memory 44 may be any type of memory or other storage device, such as random access memory (RAM), read only memory (ROM), flash memory, a hard disk drive, a combination of such devices, etc., that is suitable for storing interactive television application instructions and interactive television application data for use by the interactive television application.

Set-top box 28 may contain communications device 37 for communicating directly with interactive television application server 25 or Internet service system 61 over communications path 20. Communications device 37 may be a modem (e.g., any suitable analog or digital standard, cellular, or cable modem), network interface card (e.g., an Ethernet card, Token ring card, etc.), or other suitable communications device. Communications device 37 may also be a personal computer with an Internet connection in, for example, the arrangement shown in FIGS. 2C and 2D. Television 36 may also contain such a suitable communications device if desired. In an alternative approach, user television equipment 22 may communicate with Internet service system 61 via distribution equipment 21 using a suitable return path.

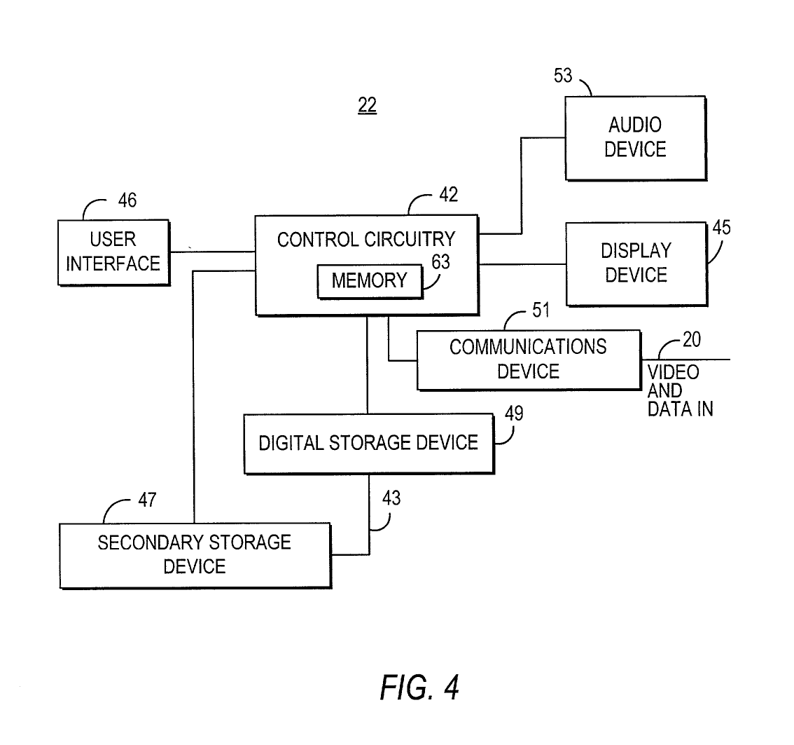

A more generalized embodiment of user television equipment 22 of FIG. 3 is shown in FIG. 4. As shown in FIG. 4, interactive television application data from television distribution facility 16 (FIG. 1) is received by control circuitry 42 of user television equipment 22. The functions of control circuitry 42 may be provided using the set-top box arrangement of FIGS. 2A and 2B. Alternatively, these functions may be integrated into an advanced television receiver, personal computer television (PC/TV), or any other suitable arrangement. If desired, a combination of such arrangements may be used.

User television equipment 22 may also contain secondary storage device 47 and digital storage device 49 for recording programming. Secondary storage device 47 can be any suitable type of analog or digital program storage device (e.g., a videocassette recorder, a digital versatile disc (DVD), digital video recorder, etc.). Program recording and other options may be controlled by control circuitry 42. Digital storage device 49 may be, for example, a writeable optical storage device (such as a DVD player capable of handling recordable DVD discs), a magnetic storage device (such as a disk drive or digital tape), or any other digital storage device.

User television equipment 22 may also contain memory 63. Memory 63 may be any type of memory or other storage device, such as random access memory (RAM), read only memory (ROM), flash memory, a hard disk drive, a combination of such devices, etc., that is suitable for storing interactive television application instructions and interactive television application data for use by control circuitry 42.

User television equipment 22 of FIG. 4 may also include communications device 51 for supporting communications between the interactive television application and distribution equipment 21 or Internet service system 61 via communications path 20. Communications device 51 may be a modem (e.g., any suitable analog or digital standard, cellular, or cable modem), network interface card (e.g., an Ethernet card, Token ring card, etc.), set-top box, television tuner, or any other suitable communications device.

The user controls the operation of user television equipment 22 with user interface 46. User interface 46 may be a pointing device, wireless remote control, keyboard, touch-pad, voice recognition system, or any other suitable user input device. To watch television, a user instructs control circuitry 42 to display a desired television channel on display device 45. Display device 45 may be any suitable television, monitor, or other suitable display device. To access the functions of the interactive television application, the user instructs the interactive television application to generate a main menu or other desired interactive television application display screen for display on display device 45. Audio information may be provided to audio device 53. In one approach, audio device 53 may be combined with display device 45 such that video and audio information is provided on one device, for example, a television.

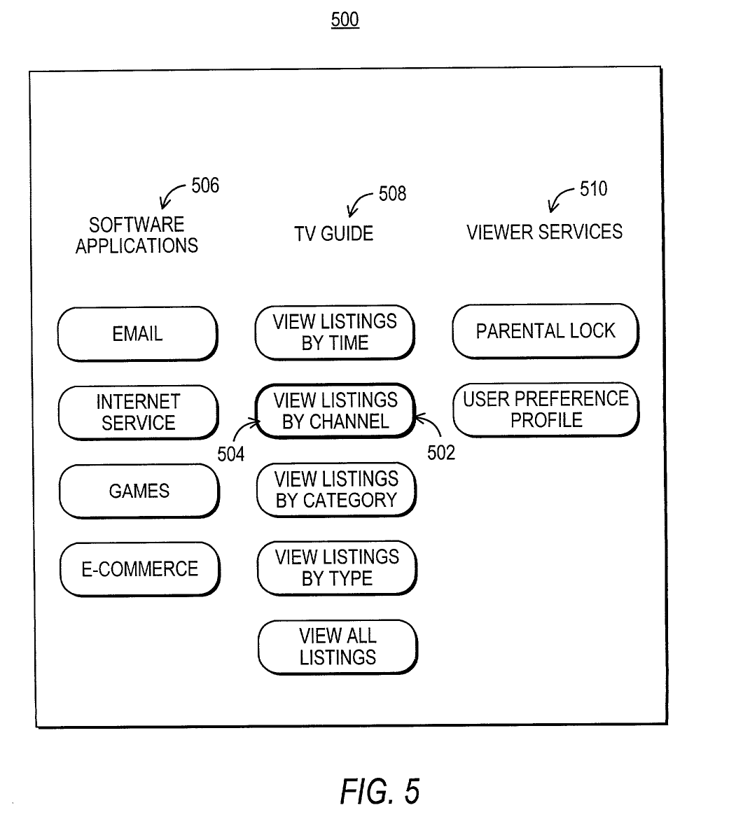

A main menu screen, such as main menu screen 500 as illustrated in FIG. 5, may be displayed by the interactive television application. Main menu screen 500 may be displayed in response to the user pressing a “Menu” key or any other suitable key on user interface 46. Menu screen 500 of FIG. 5 may include selectable menu options that the user may select with user interface 46. Menu options may include “Software Applications” options 506, “TV GUIDE” options 508, and “Viewer Services” options 510. “Software Applications” options 506 are software related options, “TV GUIDE” options 508 are program listings related options, and “Viewer Services” options 510 are user related options.

Menu screen 500 also includes highlight region 504 which is currently highlighting option 502. The user may position highlight region 504 using “up”, “down”, “left”, and “right” arrow keys on user interface 46. In one suitable approach, the user may select an option by pressing an “OK” or “Info” key on user interface 46. Alternatively, a touch sensitive screen, a trackball, a voice recognition device, or other suitable user interface may be used to position highlight region 504 or to select options 502 without the use of highlight region 504. In another suitable approach, the user may select an option by saying the option name into a voice recognition system. These approaches toward selecting interactive television applications are merely illustrative and other suitable approaches for selecting options may be used if desired.

When the user selects an option by highlighting the option and pressing a suitable key (e.g., an “OK” key) on user interface 46, the interactive television application may generate a display screen associated with the selected option. Alternatively, the interactive television application may present a display screen which is associated with an option, when the user presses a suitable key on user interface 46. For example, a display screen which contains program listings may be displayed when the user presses a suitable key (e.g., “Guide” key) on user interface 46.

“Software Applications” options 506 provide the user with the ability to launch software applications such as Internet Web pages, games, and email. Other suitable software applications such as e-commerce applications may also be provided by the interactive television application. In one approach, data and instructions for software applications may be stored in memory 44 of set-top box 28, as shown in FIG. 3. The data and instructions for software applications may be downloaded to set-top box 28 periodically or continuously from television distribution facility 17. For example, a cached Internet Web page that is stored in set-top box 28 may be accessed by the user with the interactive television application. In another suitable approach, data and instructions for software applications may be provided over link 18, in real-time, between main facility 12 and interactive television application equipment 17 (as illustrated in FIG. 1). For example, the user may access an Internet Web page in real-time by dialing up an Internet service provider, with communication between the user and the service provider taking place over link 18.

“TV GUIDE” options 508 may provide the user with the ability to view program listings by time, channel, category, and type, and to view all program listings. In response to a user selection of a “TV GUIDE” option, the interactive television application may display the appropriate program listings in a program listings screen. A program listings screen may include listings for television programs, interactive advertisements, pay-per-view programs, music channels, video-on-demand (VOD) programs, near video-on-demand (NVOD) programs, digital audio programs, Internet Web data, games, or any listings for any other suitable type of program. “Viewer Services” options 510 may provide the user with the ability to set system parameters such as parental locks on programs and to set up user preference profiles. Menu screen 500 is merely illustrative and the user may be provided with user selectable options in any other suitable format.

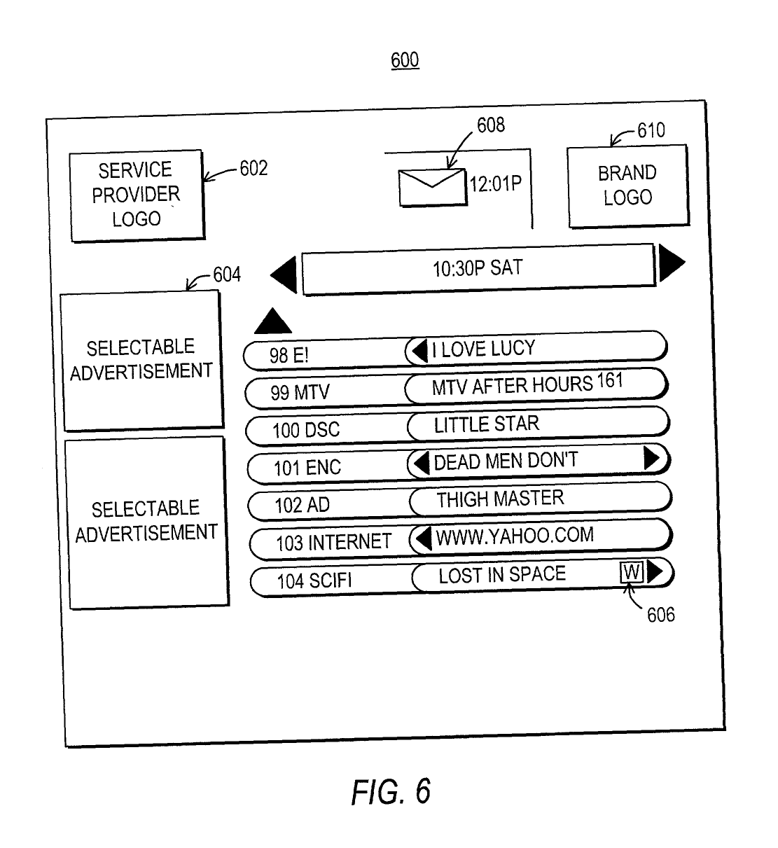

When the user selects “View Listings by Time” option from “TV GUIDE” options 508 in FIG. 5, display screen 600 may be displayed, as illustrated in FIG. 6. Display screen 600 of FIG. 6 includes listings for programs available to the user at a specific time. If programs are on a watch list, indicators such as indicator 606 may be displayed. Display screen 600 may also include logos such as service provider logo 602, which may identify a television service provider, and brand logo 610, which advertises a brand of products or services such as a brand of interactive television application. Display screen 600 may also include interactive advertisement 604 which the user may view by positioning highlight region 504 over interactive advertisement 604 and pressing a suitable key on user interface 46. Mail indicator 608 may indicate unread email messages that may be viewed by the user when the user selects mail indicator 608, or when the user selects an email related option from “Software Applications” options 506 of FIG. 5.

Data for interactive advertisement 604 may be transmitted as a broadcast from main facility 12 to interactive television application equipment 17, as illustrated in FIG. 1. In another suitable approach, data for interactive advertisements may be transmitted to interactive television application equipment 17 and stored on user television equipment 22, to be retrieved and displayed when the user selects interactive advertisement 604.

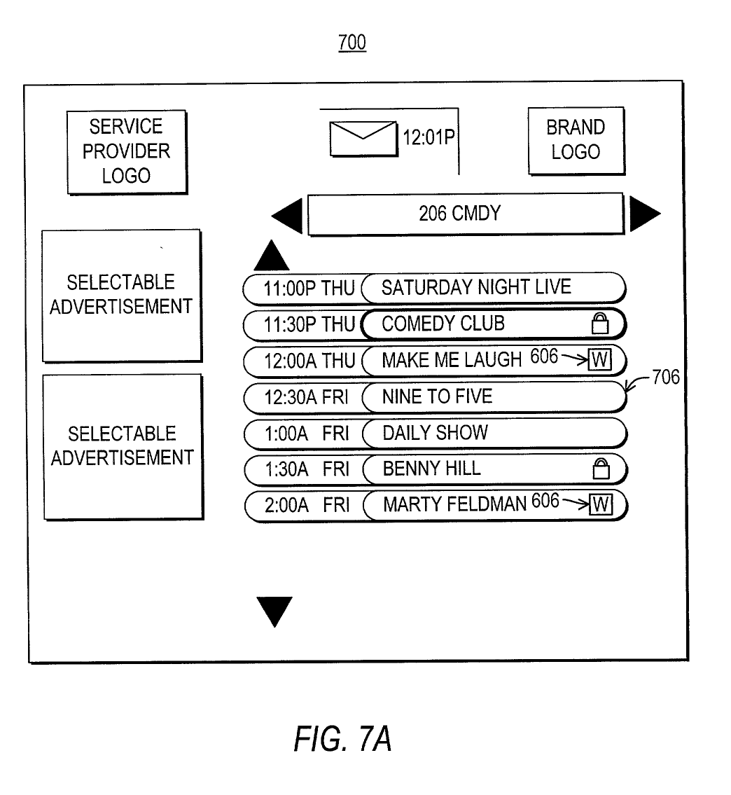

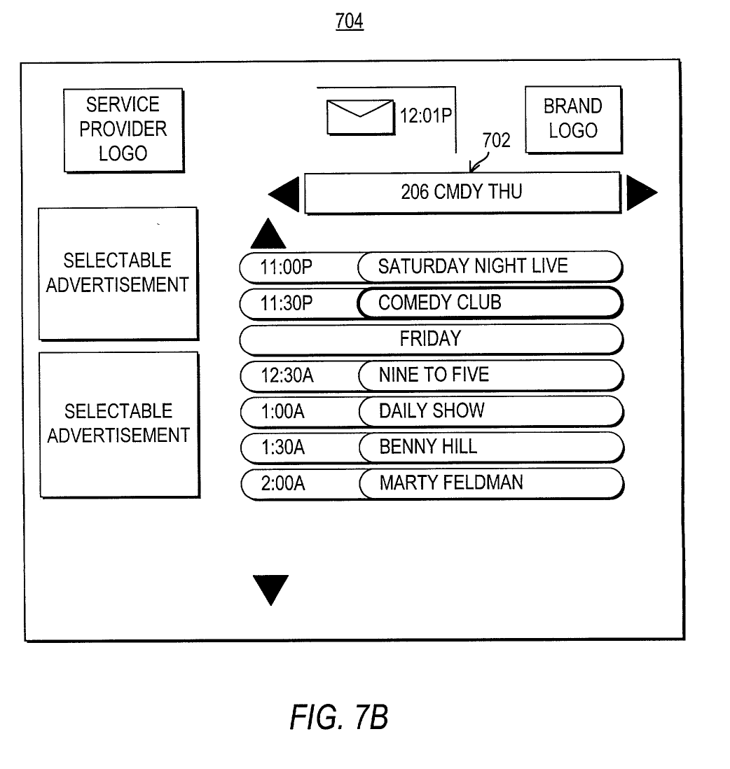

When the user selects “View Listings by Channel” option from “TV GUIDE” options 508 of FIG. 5, display screen 700 and display screen 704 may be shown, as illustrated in FIG. 7A and FIG. 7B. Display screens 700 and 704 display program listings that are organized by channel. The user may scroll up and down to view program listings for additional time slots, and may scroll left and right to view program listings for other channels. As illustrated in display screen 700 of FIG. 7A, each program is listed with its air time and day. If desired, the day for which program listings are displayed may be included in display area 702 with the channel number as shown in FIG. 7B. The day displayed may correspond to the day of the program associated with the first displayed listing.

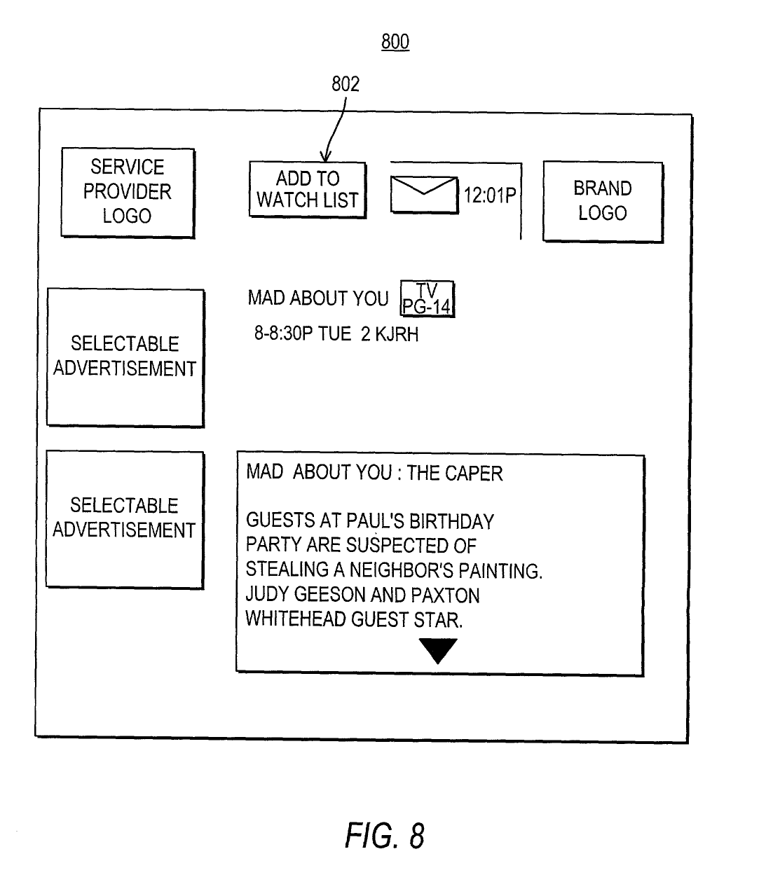

The interactive television application may provide the user with the ability to view additional information about a particular program, such as all of the times a program is available. The user may access the additional information by highlighting its listing with highlight region 504 and pressing a suitable key on user interface 46. Additional information may be provided by the interactive television application in a program information screen. Program information screens provide the user the ability to view the air times for a program and to view other suitable information (e.g., the title, a brief description, rating information, artist information, corporate information, etc.). Program information screens are described in commonly-assigned Rudnick et al. U.S. patent application Ser. No. 09/356,268, filed Jul. 16, 1999 which is hereby incorporated by reference herein in its entirety. When the user selects an option from display screen 700, more information about a program entitled, for example, “Mad About You” from channel “2 KJRH”, a program information screen such as display screen 800, as illustrated in FIG. 8, may be displayed in response to the user selection. The interactive television application may provide the user with the ability to perform other functions from within display screen 800, such as adding programs to a watch list.

Watch lists are interactive lists of programs that are of current interest to the user. The watch list may contain any combination of programs such as television programs, interactive advertisements, pay-per-view programs, music channels, video-on-demand (VOD) programs, near video-on-demand (NVOD) programs, previously recorded programs, digital audio programs, Internet Web data, games, or any other programs available to the user. If a program is on the watch list, reminders may be provided to the user before the program starts. The interactive television application may remind the user by displaying, for example, graphics on display device 45. The graphics may include icons, text or any suitable graphic. In another suitable approach, the interactive television application may present audio reminders to the user to indicate that a program on the watch list is about to begin. Program reminders are described in commonly-assigned Knudson et al. U.S. patent application Ser. No. 09/357,941, filed Jul. 16, 1999 which is hereby incorporated by reference herein in its entirety.

Programs may be added to the watch list in several different ways. In one approach, programs may be added to the watch list by the user from within program information screens corresponding to the programs. As shown in FIG. 8, the user may select “Add to Watch List” option 802 with user interface 46 in order to add the corresponding program to the watch list.

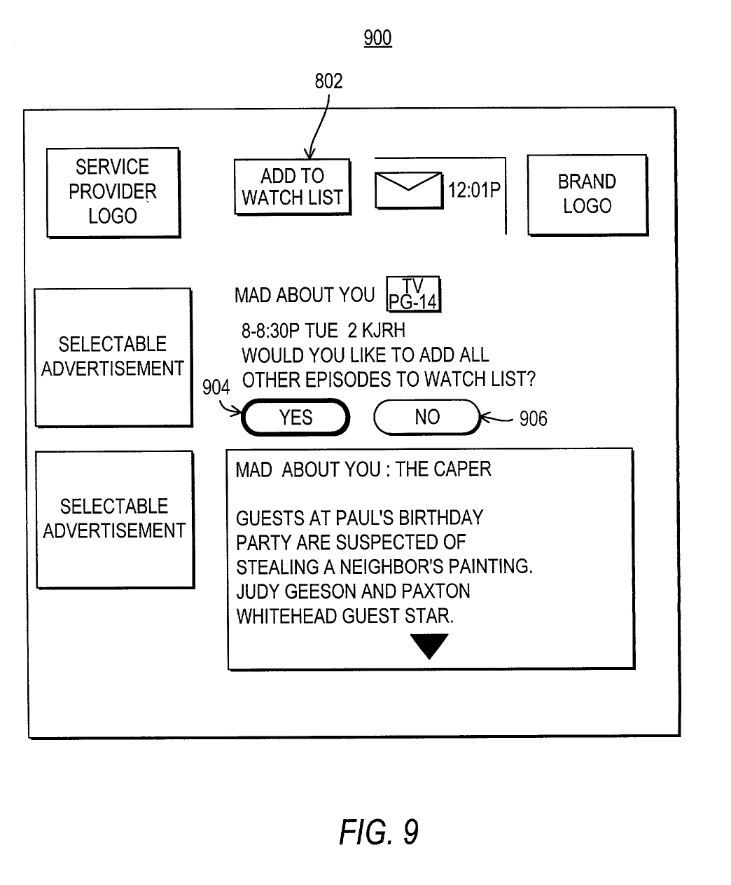

Before a program is added to the watch list, the interactive television application may ask context-sensitive questions of the user. For example, if the program is part of a series, the user may be asked if future episodes are also to be added to the watch list. In one suitable approach, the user is prompted to answer “Yes” or “No” in response to the question, “Would you like to add all other episodes to the watch list?” Illustrative display screen 900 of FIG. 9 shows a program information screen in which the user is being asked if future episodes are to be added to the watch list. The user may answer “Yes” or “No” by selecting either “Yes” option 904 or “No” option 906 with user interface 46. Reminders for programs that are part of a series are described commonly-assigned Knudson et al. U.S. patent application Ser. No. 09/330,792, filed Jun. 11, 1999 which is hereby incorporated by reference herein in its entirety.

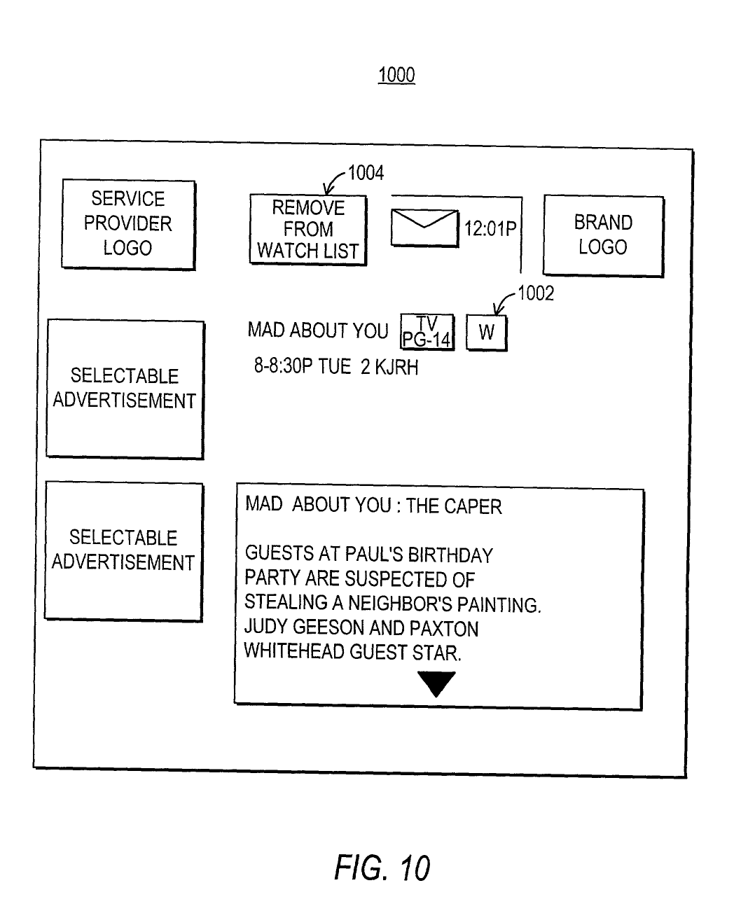

Other context-sensitive questions that may be asked of the user by the interactive television application may include questions as to whether repeat showings of the program should be added to the watch list and whether other programs in the same time slot should be added to the watch list. Illustrative display screen 1000 as shown in FIG. 10, includes watch indicator 1002 that indicates the program has been added to the watch list. When a program is already on the watch list, the content of option 802 may change from “Add to Watch List” to “Remove from Watch List” as illustrated in FIG. 10.

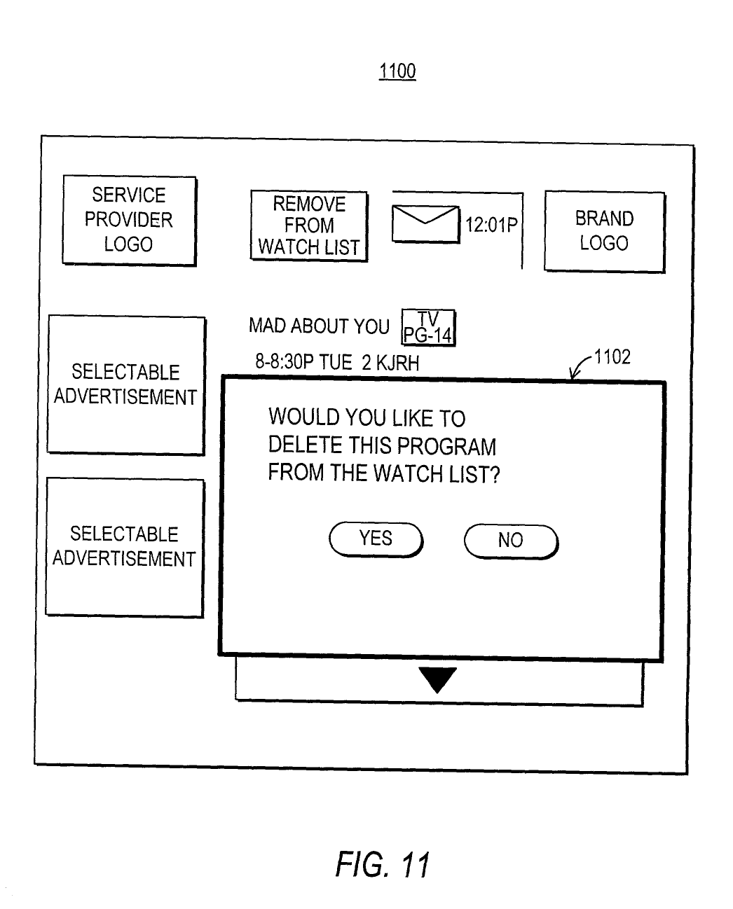

After the user selects option 802, as shown in FIG. 10, for a program that is on the watch list, the interactive television application may display screen 1100 as illustrated in FIG. 11. Display screen 1100 includes prompt 1102 which asks the user if the television program should be removed from the watch list. If the television program is removed from the watch list, indicator 1002 of FIG. 10 may be removed.

The interactive television application may provide the user with the ability to add as many programs to the watch list as desired, from within program information screens. The number of programs on the watch list may, however, be constrained by either system resources or limits set by the interactive television application.

In addition to adding programs to the watch list from within program information screens, programs may also be added automatically to the watch list by the interactive television application. In one approach, programs may be added to the watch list based on a user preference profile. The creation of user preference profiles is described in commonly-assigned Ellis et al. U.S. patent application Ser. No. 09/034,934, filed Mar. 4, 1998 which is hereby incorporated by reference herein in its entirety.

In one approach, if the user has been watching a program for a specified amount of time, the program will be automatically added to the watch list. If a program has been on the watch list, and not been watched for a specified amount of time, the program may be removed from the watch list. In another approach, the interactive television application may monitor what the user is watching in order to find user-preferred programs to add automatically to the watch list. For example, the interactive television application may build a list of all programs that have been watched by the user. Each of the programs may be assigned a ranking that is based on the amount of time that the user has spent watching the program. Program rankings may be adjusted depending on program type. For example, if interactive advertisements are shorter in duration compared to television programs, rankings of interactive advertisements may be modified to reflect this fact. Additional techniques for monitoring user interaction with interactive television applications are described in commonly-assigned Thomas et al. U.S. patent application Ser. No. 09/139,798, filed Aug. 25, 1998.

In addition, the interactive television application may also automatically add programs that the user has not watched to the watch list based on user preferences. For example, programs that share characteristics, with programs that have been added to the watch list, may be added to the watch list. If there is more than one user, the interactive television guide may automatically add programs that are of interest to a particular user to the corresponding watch list. The interactive television program application may also review programs on the watch list that were automatically added based on user preferences. For example, if user preferences have changed, the interactive television programs may remove programs on the watch list which no longer correspond to user preferences. In another suitable approach, the interactive television application may add programs to the watch list independent of any user actions or preferences. For example, programs may be added to the watch list for promotional purposes.

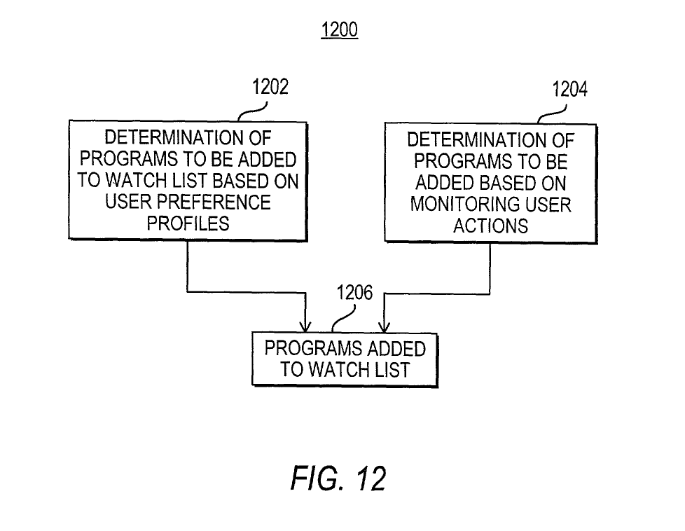

FIG. 12 shows flow chart 1200 of illustrative steps that may be involved in automatically adding programs to the watch list. At step 1202, the interactive television application may determine programs to be added to the watch list based on user preference profiles. At step 1204, the interactive television application may monitor the user's actions. For example, the interactive television application may start to time the length of time that the user is tuned to a program. When the user tunes to another program, the interactive television application may then determine the length of time that the user was tuned to the previous program. The previous program is then assigned a ranking in a list of previously watched programs. The interactive television application may periodically or continuously determine what characteristics are shared by programs watched by the user. The interactive television application may also monitor automatically add programs that are recorded by the user to the watch list, as well as programs that are purchased by the user. At step 1206, the interactive television application may add programs to the watch list based on the user's actions, or the user preference profile. The interactive television application may add programs periodically, continuously, or at suitable time intervals.

The interactive application also provides the user with the ability to display the watch list. In one approach, when a user tunes to a program on the watch list, the watch list may be displayed for a predetermined amount of time. In another suitable approach, the interactive application may display the watch list when the user presses a suitable key on user interface 46. The amount of time that the watch list is displayed may be determined by fixed system parameters, by user settings, or by any other suitable approach.

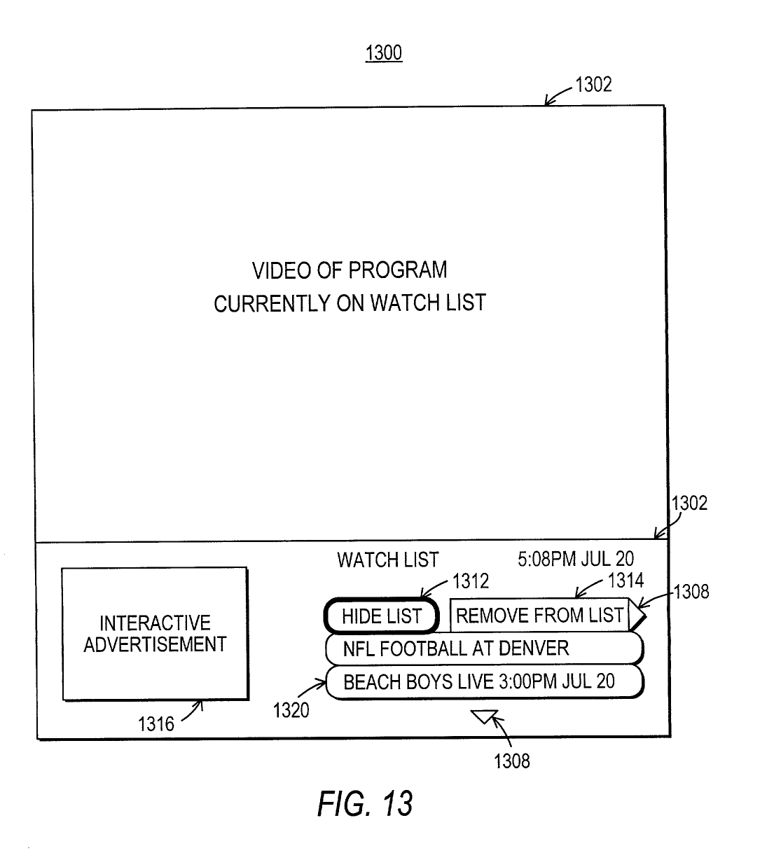

FIG. 13 shows illustrative display screen 1300 of a suitable watch list arrangement that is overlaid over a program on the watch list. Watch list 1302 may be displayed by the interactive television application at the start of the program, or in response to a suitable user input. In this arrangement, the interactive television application may provide the user with the ability to view the watch list while still viewing a portion of the currently displayed program. Watch list 1302 may be removed after a predetermined amount of time or after the user presses a suitable key on user interface 46.

The interactive television application may provide the user with the ability to navigate through the watch list. Watch list 1302 of FIG. 13 includes indicators 1308 to indicate that additional watch list options and watch list programs are available. The user may access additional options associated with a highlighted option, by pressing suitable keys on user interface 46 (e.g., arrow keys). For example, each displayed option may have associated arrow indicators that indicate the availability of additional options, which may be accessed when the user presses an arrow key corresponding to the arrow indicators. For example, in FIG. 13, highlight region 504 may be positioned further down the displayed watch list, by highlighting program 1320 and pressing a “down” arrow key on user interface 46.

As illustrated in FIG. 13, watch list 1302 also includes highlighted “Hide List” option 1312 that removes the watch list from display when the user presses a suitable key such as an “OK” key on user interface 46. The user may also remove the currently displayed program from the watch list by selecting “Remove from List” option 1314. The interactive television application may also display the title of the program and the broadcast time of the program or other information related to the program such as ratings, in the manner illustrated with program 1320.

The interactive television application may also provide the user with the ability to view interactive advertisement 1316 of FIG. 13 by positioning highlight region 504 and pressing a suitable key on user interface 46. The user may add interactive advertisements to the watch list when the user is interacting with a particular interactive advertisement. In one approach, the user may access the watch list by pressing a suitable key on user interface 46, and then adding an interactive advertisement that the user is interacting with, to the watch list. In another suitable approach, an option such as option 802 of FIG. 8 may be displayed that the user may select to add the interactive advertisement to the watch list. Interactive advertisements may also be added automatically to the watch list.

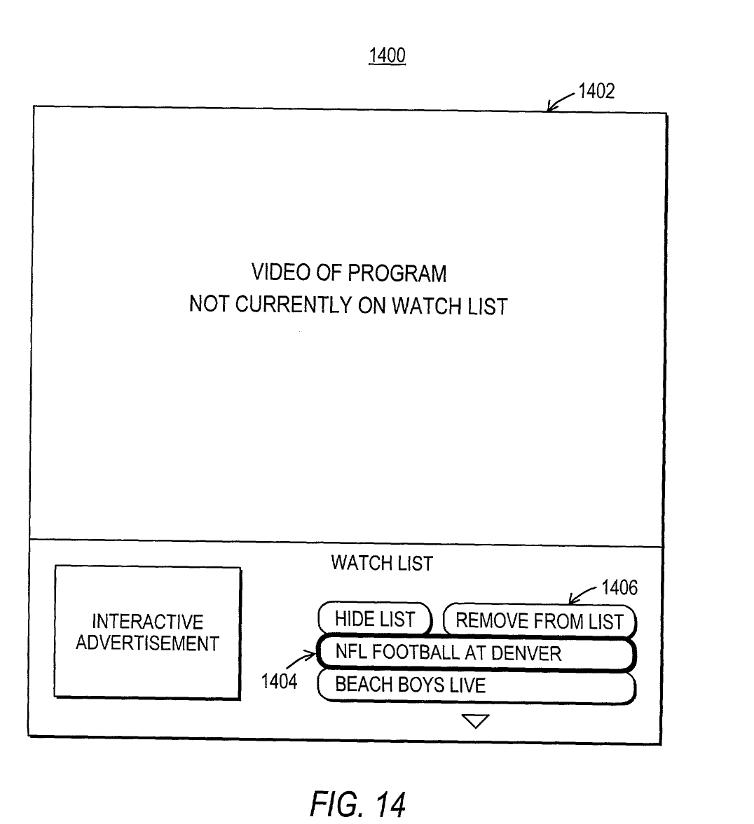

The interactive television application may also be configured to display the watch list at some pre-determined period of time before the start of a particular program that is on the watch list. The particular program that is about to begin may be displayed at the top of the watch list, irrespective of any sort criteria settings for the watch list. In FIG. 14, illustrative display screen 1400 shows watch list 1402 overlaid over a currently displayed program that is not on the watch list because a particular program on the watch list, “NFL Football at Denver” is about to start. Television program “NFL Football at Denver” 1404 may be displayed at the top of the watch list. Television program “NFL Football at Denver” 1404 may also be highlighted as a default selection on the watch list.

As shown in FIG. 14, the currently displayed program in FIG. 14 may be added to the watch list by the interactive television application if the user desires. The user may select “Add to List” option 1406 to add the currently displayed program to the watch list. The user may also be prompted to add future showings of the currently displayed television program to the watch list, when there are repeat showings of the program, when there is more than one episode of the television program, or any other appropriate occasion.

When the user selects “NFL Football at Denver” option 1404 by highlighting it with highlight region 504 and presses an appropriate key on user interface 46 to select highlighted option 1404, the interactive television application may tune display device 45 to the corresponding program. Alternatively, the user may highlight option 1404, and press a suitable key such as “Info” key on user interface 46 to display information about “NFL Football at Denver.” When programs on the watch list are not currently available and are selected in this manner by the user, interactive advertisements related to the unavailable programs, messages indicating the future availability of the unavailable programs, previews, or any other suitable video or screen may be displayed by the interactive television application. In another suitable approach, programs that are not available are not displayed on the watch list.

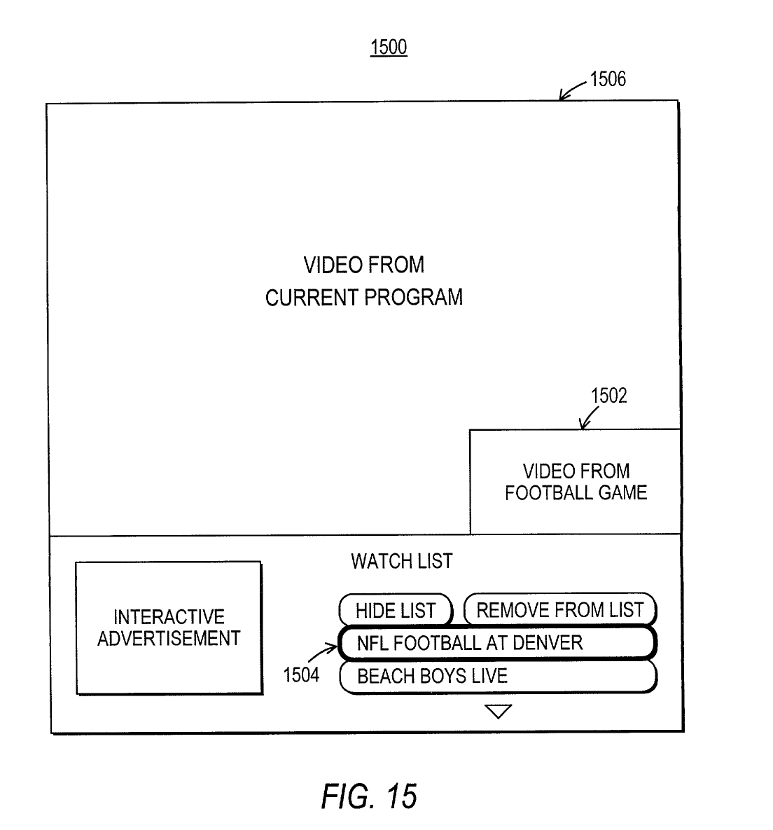

Illustrative display screen 1500 of FIG. 15 shows another suitable watch list arrangement in which a program on the watch list is overlaid over a currently displayed program. In FIG. 15, program window 1502 is overlaid on currently displayed program 1506. Program window 1502 corresponds to program 1504 that is highlighted in the watch list. When a program from the watch list is not available, other video or other suitable programs or images related to the program may be displayed in program window 1502.

In another approach, other than that shown in FIGS. 13-15, the watch list may be displayed in a non-overlay mode. FIGS. 13-15 show display screens in which watch lists are overlaid over a currently displayed program. The interactive television application may provide a display mode feature that may be toggled by the user so that the interactive television application can switch back and forth between displaying the watch list in an overlay-type display mode, and the non-overlay-type display mode. In the non-overlay-type display mode, the length and width of video associated with a currently displayed program may be reduced in scale, so that the watch list may be viewed by the user without overlaying the watch list. The interactive television application may keep the aspect ratio of the currently displayed television program constant in order to eliminate distortion of the video. In another suitable approach, the interactive television application may provide one display mode, depending on the display capabilities of the system.

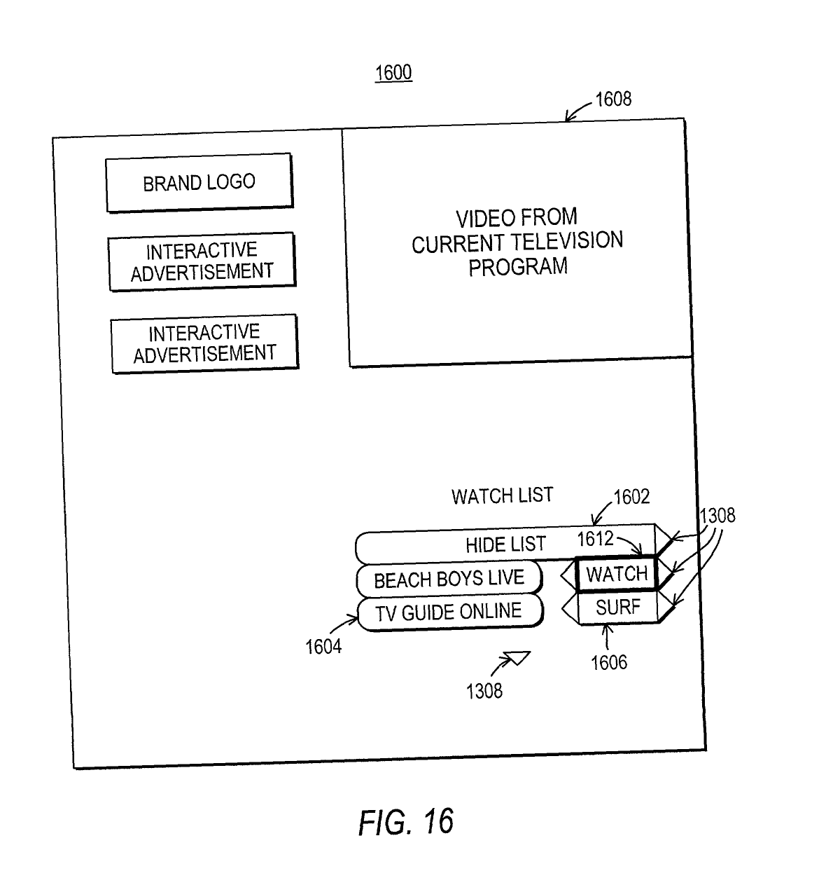

An arrangement of the watch list in accordance with the non-overlay display mode is shown in FIG. 16. Illustrative display screen 1600 of FIG. 16 shows a watch list that is not overlaid over currently displayed program 1608. The interactive television application may also provide context-specific options associated with each program on the watch list. Since the present invention does not limit programs on the watch list by type (e.g., television programs), different options may be more appropriate for some types of programs as opposed to other types of programs. For example, as shown in FIG. 16, “Surf” option 1606 may be suitably provided for Internet Web page 1604 on the watch list, as opposed to “Watch” option 1612. In addition, a “Play” option may be provided for games; a “Download”/“View Image” option may be provided for software applications; and a “Listen” option may be provided for music. Other options may include a “Delete” option or an “Info” option.

In addition to providing users with the ability to add programs to the watch list, the interactive television application may also provide the user with the ability to set up the watch list. In one suitable approach, the user may access a “Watch List Setup” option by positioning highlight region 504 on “Hide List” option 1602 of FIG. 16 and pressing the “right” arrow key on user interface 46.

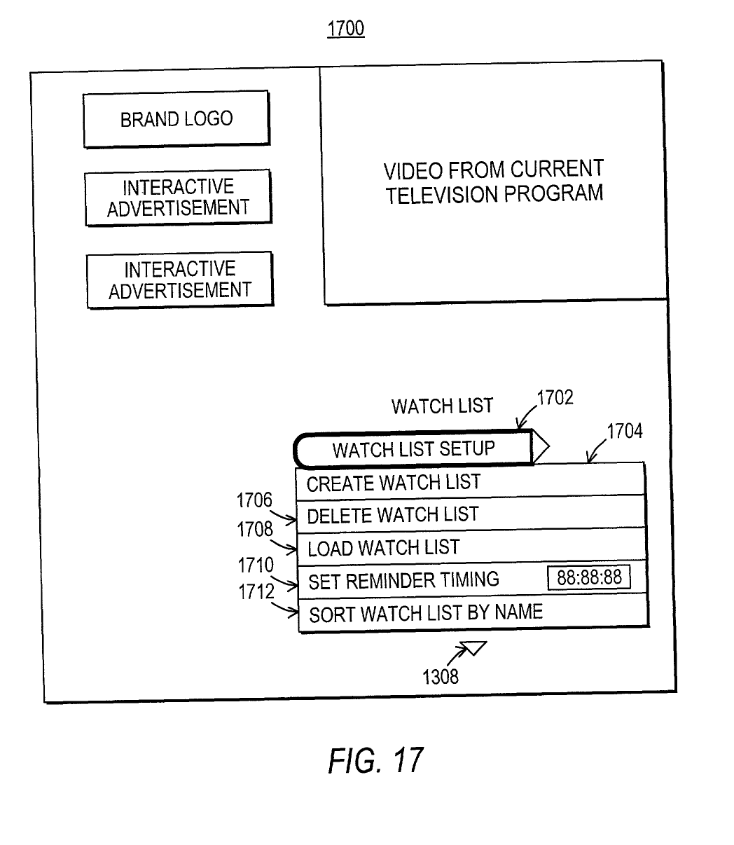

After the “Watch List Setup” option has been selected, display screen 1700 as illustrated in FIG. 17 may be provided by the interactive television application. Watch list setup menu 1704 of FIG. 17 may include watch list setup options, such as “Create Watch List” option 1704, “Delete Watch List” option 1706, “Load Watch List” option 1708, and “Set Reminder Timing” option 1710, and “Sort Watch List by Name” option 1712. Additional options that are not displayed in FIG. 17 may be accessed when the user positions highlight region 504 over option 1712 and presses the “down” arrow key on user interface 46. Other options may include options that may be selected to sort the watch list by program start time, program type, channel or channel identifier, broadcast/show time, most recent time viewed, program name, or any other criteria, to navigate the watch list with a single key (“single-key navigation”), to toggle the display mode, to set the period of time that the watch list is displayed, to change or add user preference profiles, and any other suitable option associated with setting up the watch list.

“Create Watch List” option 1704 may provide the user with the ability to create a new watch list. When the user selects option 1704, the user may be prompted by the interactive television application to provide a name under which the new watch list is saved. “Delete Watch List” 1706 may provide the user with the ability to delete a watch list. “Load Watch List” option 1708 may provide the user with the ability to make a particular watch list the current watch list. “Set Reminder Timing” option 1710 may provide the user with the ability to set the period of time that the watch list is displayed before a program on the watch list begins. “Sort Watch List by Name” option 1712 may provide the user to sort the watch list alphabetically.

The single-key navigation option may provide the user with the ability to view programs on the watch list without having the watch list displayed on display device 45. In one approach, the user can press a “Next” key (or any suitable key) on user interface 46 to tune display device 45 to the next program on the watch list. For example, the next program may be the next available program on the watch list. The interactive television application may also provide the user with the ability to watch the previous program on the watch list when the user presses a “Back” key (or any suitable key) on user interface 46. For example, the previous program may be a previously watched program on the watch list.

Other suitable approaches in addition to the non-overlay display mode illustrated in FIGS. 16-17 may be provided that do not result in the watch list obscuring a currently displayed program. In one suitable approach, user interface 46 may be implemented as a touch-screen remote control. Touch-screen remote controls include touch-sensitive graphical displays which may be used to display the watch list. Interactive television guides with touch-screen displays are described, for example, in commonly-assigned Herrington et al. U.S. patent application Ser. No. 60/138,868, filed Jun. 11, 1999, which is hereby incorporated by reference herein in its entirety. The watch lists shown in FIG. 13-17 may be additionally or exclusively be displayed on a touch-screen remote control, instead of being exclusively displayed on display device 45.

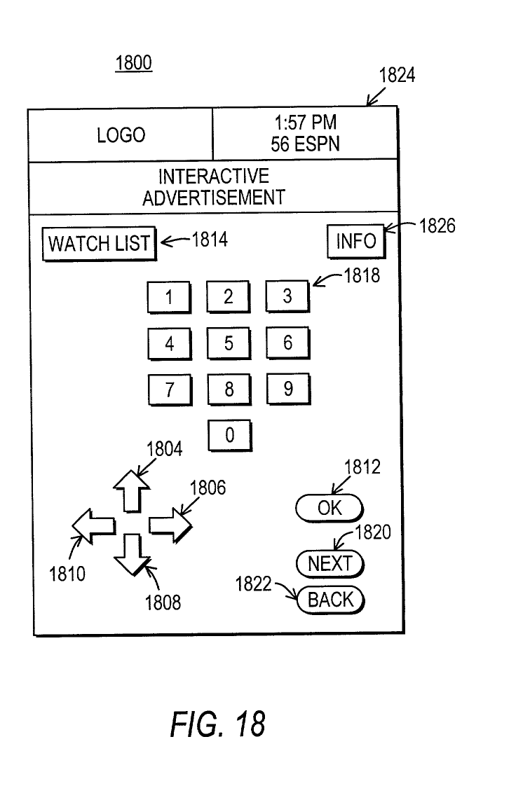

As illustrated in FIG. 18, user interface 46 may be implemented as touch-screen remote control 1800. While touch-screen 1800 includes options that may be selected when the user touches the area of the options, the options will be referred to as keys for simplicity. Touch-screen remote control 1800 includes numerical keys 1818, “top” arrow key 1804, “right” arrow key 1806, “down” arrow key 1808, and “left” arrow key 1810, “OK” key 1812, “Next” key 1820, “Back” key 1822, “Watch List” key 1814, and “Info” key 1826. The watch list may be displayed on both remote control 1800 and display device 45, or on either device exclusively. Remote control 1800 may also include current time and channel indicator 1824. “Info” key 1826 may be touched by the user, in order to access information about selected programs on the watch list. The information may be displayed on display device 45 or remote control 1800. Interactive advertisement 1816 may be accessed by the user by touching the area of interactive advertisement 1816.

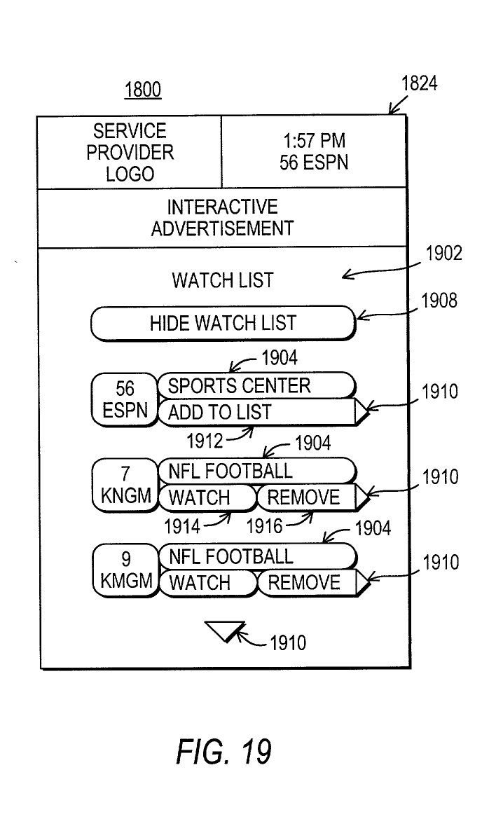

When the user touches “Watch List” key 1814, the watch list may be displayed on remote control 1800, as illustrated in FIG. 19. The interactive application may provide the user with the ability to add currently displayed program 1904 (which corresponds to channel indicated by indicator 1824) to the watch list by providing “Add to List” option 1912 if the program is not already on the watch list. For programs already on the watch list, the interactive application may provide options such as “Watch” option 1914 and “Remove” option 1916, that allow the user to view the corresponding program, or to remove the corresponding program from the watch list, respectively. Additional options that are not displayed on remote control 1800 may be displayed when the user touches indicators 1910. Additional options may include an “Info” option that allows the user view more information about programs, either on display device 45 or remote control 1800.

When the user uses watch list options such as “Watch” option, “Surf” option, “Next” option, “Back” option, or any other suitable options to switch display device 45 from being tuned to non-broadcast programs such as video-on-demand programs (VOD), near video-on-demand programs (NVOD), previously recorded programs, interactive advertisements, Internet Web pages, games, and software applications, the user may desire to leave and return to the non-broadcast programs in the same state. The interactive television application may save the state of non-broadcast programs on user television equipment 17 or any other suitable equipment associated with the interactive television application, when the user leaves the program. The interactive television application may then revert to the last saved state of a particular non-broadcast program when the user returns to the program.

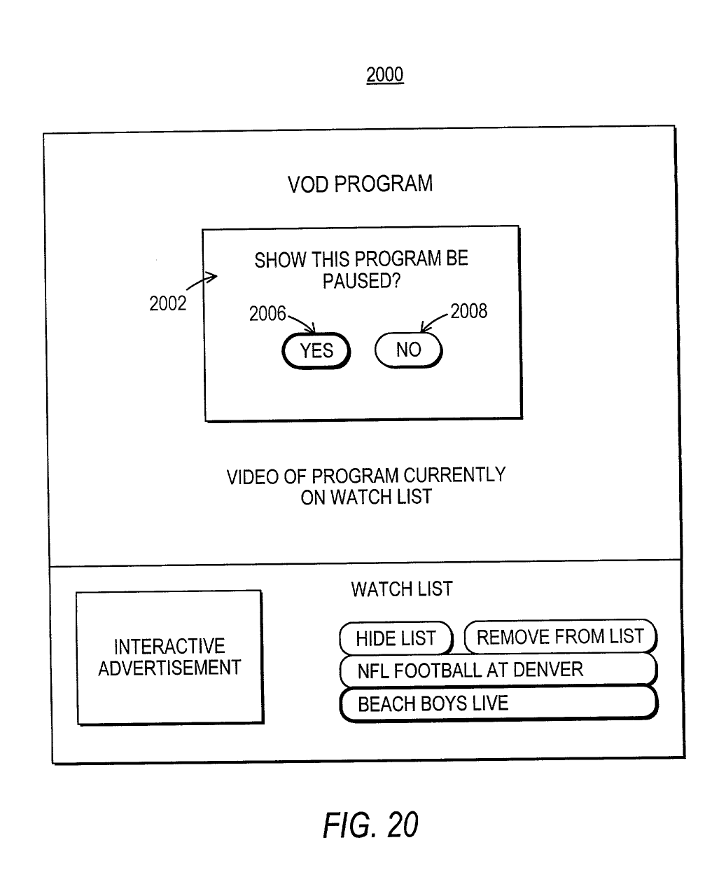

In one suitable approach, if a non-broadcast program such as a VOD program is displayed, the VOD program may be automatically paused when the user switches to watching another program. In another suitable approach, the interactive television application may pause the VOD program upon sensing that the user desires to watch another program. In yet another approach, the interactive application may record a previous program that the user was watching after the user has switched to another program. When the user returns to the previous program, the user is watching the recorded portion of the previous program. The user may be asked if the VOD program should continue to be paused for the duration that the user is not tuned to the VOD program, as illustrated in FIG. 20 with prompt 2002 on display screen 2000. The interactive television application may provide the user with a choice between “Yes” option 2006 and “No” option 2008. When the user selects “Yes” option 2006, the VOD program is paused for the duration that the user is not watching the VOD program, and may be resumed if the user desires. Other non-broadcast programs that may be paused and restarted in the same manner as VOD programs include software applications such as games, e-commerce applications, and e-mail applications.

The foregoing is merely illustrative of the principles of this invention and various modifications may be made by those skilled in the art with departing from the scope and spirit of the invention.

What is claimed is:

1. A method for reminding a user with an interactive television application that at least one program is about to start, comprising:
providing the user with the ability to add the program to a watch list; and
automatically prompting the user to add future showings to the watch list.

2. The method of claim 1, wherein the program is one of a television program, a video-on-demand program, a near video-on-demand program, a previously recorded program, an Internet Web page, a music channel, a digital audio program, a game, or a software application.

3. The method of claim 1, wherein the future showings comprise future episodes of the program.

4. The method of claim 1, wherein the future showings comprise repeat showings of the program.

5. The method of claim 1, wherein the user is reminded of the program on the watch list when the program is about to begin.

6. A method for reminding a user with an interactive television application that at least one program is about to start, comprising:
providing the user with the ability to add the program to a watch list; and
displaying the watch list, wherein displaying the watch list comprises a list of programs that are on the watch list and watch list options for each program on the watch list.

7. The method of claim 6, wherein the program is one of a television program, a video-on-demand program, a near video-on-demand program, a previously recorded program, an Internet Web page, a music channel, a digital audio program, a game, or a software application.

8. The method of claim 6, wherein the watch list options comprise an option for displaying the program on the watch list.

9. The method of claim 6, wherein the watch list options comprise an option for removing the program from the watch list.

10. The method of claim 6, wherein the watch list options comprise an option for displaying information about programs on the watch list.

11. The method of claim 6, wherein the watch list is displayed on a touch-screen remote control.

12. A method for reminding a user with an interactive television application that at least one program is about to start, comprising:
providing the user with the ability to add the program to a watch list; and
providing the user with the ability to navigate between programs on the watch list without displaying the watch list.

13. The method of claim 12, wherein the program is one of a television program, a video-on-demand program, a near video-on-demand program, a previously recorded program, an Internet Web page, a music channel, a digital audio program, a game, or a software application.

14. The method of claim 12, wherein the user may navigate the watch list by pressing a key on a user input device.

15. The method of claim 12, wherein the user may watch a next program on the watch list by pressing a key on a user input device.

16. The method of claim 12, wherein the user may watch a previous program on the watch list by pressing a key on a user input device.

17. A method for reminding a user with an interactive television application that at least one program is about to start, comprising:
providing the user with the ability to add the program to a watch list;
displaying the watch list; and
displaying at least one program while the watch list is displayed, wherein the program is reduced in size for display so that the watch list does not obscure the program.

18. The method of claim 17, wherein the program is one of a television program, a video-on-demand program, a near video-on-demand program, a previously recorded program, an Internet Web page, a music channel, a digital audio program, a game, or a software application.

19. A method for reminding a user with an interactive television application that at least one program is about to start, comprising automatically adding a program to a watch list based on user preferences.

20. The method of claim 19, wherein the program is one of a television program, a video-on-demand program, a near video-on-demand program, a previously recorded program, an Internet Web page, a music channel, a digital audio program, a game, or a software application.

21. A method for reminding a user with an interactive television application that at least one program is about to start, comprising automatically removing a program from a watch list based on user preferences.

22. The method of claim 21, wherein the program is one of a television program, a video-on-demand program, a near video-on-demand program, a previously recorded program, an Internet Web page, a music channel, a digital audio program, a game, or a software application.

23. A system for reminding a user of an interactive television application that at least one program is about to start, comprising:
circuitry that provides the user with the ability to add the program to a watch list and that automatically prompts the user to add future showings to the watch list.

24. The system of claim 23, wherein the program is one of a television program, a video-on-demand program, a near video-on-demand program, a previously recorded program, an Internet Web page, a music channel, a digital audio program, a game, or a software application.

25. The system of claim 23, wherein the future showings comprise future episodes of the program.

26. The system of claim 23, wherein the future showings comprise repeat showings of the program.

27. The system of claim 23, wherein the user is reminded of the program on the watch list when the program is about to begin.

28. A system for reminding a user of an interactive television application that at least one program is about to start, comprising circuitry that provides the user with the ability to add the program to a watch list and that displays the watch list, wherein displaying the watch list comprises a list of programs that are on the watch list and watch list options for each program on the watch list.

29. The system of claim 28, wherein the program is one of a television program, a video-on-demand program, a near video-on-demand program, an Internet Web page, a music channel, a digital audio program, a game, or a software application.

30. The system of claim 28, wherein the watch list options comprise an option for displaying the program on the watch list.

31. The system of claim 28, wherein the watch list options comprise an option for removing the program from the watch list.

32. The system of claim 28, wherein the watch list options comprise an option for displaying information about programs on the watch list.

33. The system of claim 28, wherein the watch list is displayed on a touch-screen remote control.

34. A system for reminding a user of an interactive television application that at least one program is about to start, comprising circuitry that provides the user with the ability to add the program to a watch list and that provides the user with the ability to navigate between programs on the watch list without displaying the watch list.

35. The system of claim 34, wherein the program is one of a television program, a video-on-demand program, a near video-on-demand program, a previously recorded program, an Internet Web page, a music channel, a digital audio program, a game, or a software application.

36. The system of claim 34, wherein the user may navigate the watch list by pressing a key on a user input device.

37. The system of claim 34, wherein the user may watch a next program on the watch list by pressing a key on a user input device.

38. The system of claim 34, wherein the user may watch a previous program on the watch list by pressing a key on a user input device.

39. A system for reminding a user of an interactive television application that at least one program is about to start, comprising circuitry that provides the user with the ability to add the program to a watch list, that displays the watch list, and that displays at least one program while the watch list is displayed, wherein the program is reduced in size for display so that the watch list does not obscure the program.

40. The system of claim 39, wherein the program is one of a television program, a video-on-demand program, a near video-on-demand program, a previously recorded program, an Internet Web page, a music channel, a digital audio program, a game, or a software application.

41. A system for reminding a user of an interactive television application that at least one program is about to start, comprising automatically adding a program to a watch list based on user preferences.

42. The system of claim 41, wherein the program is one of a television program, a video-on-demand program, a near video-on-demand program, a previously recorded program, an Internet Web page, a music channel, a digital audio program, a game, or a software application.

43. A system for reminding a user of an interactive television application that at least one program is about to start, comprising automatically removing a program to a watch list based on user preferences.

44. The system of claim 43, wherein the program is one of a television program, a video-on-demand program, a near video-on-demand program, a previously recorded program, an Internet Web page, a music channel, a digital audio program, a game, or a software application.

45. A method of providing program access to a user, comprising:
adding a program of interest to a watch list based on at least one user action;
displaying the watch list in response to user input while the user is watching a program;
allowing the user to indicate a program on the displayed watch list;
allowing the user to indicate an action to be performed that is related to the indicated program; and
performing the indicated action.

46. The method of claim 45, wherein the program of interest is one of a television program, a video-on-demand program, a near video-on-demand program, a previously recorded program, an Internet web page, a music channel, a digital audio program, a game, or a software application.

47. The method of claim 45, wherein the user action comprises selecting the program of interest in an interactive program guide.

48. The method of claim 45, wherein the user action comprises purchasing the program of interest.

49. The method of claim 45, wherein the user action comprises recording the program of interest.

50. The method of claim 45, wherein programs related to the program of interest are also added to the watch list.

51. The method of claim 50, wherein the programs related to the program of interest are episodes of the same program series.

52. The method of claim 45, wherein the user action comprises defining a preference profile.

53. The method of claim 50, further comprising automatically removing the program of interest from the watch list when the user changes the preference profile.

54. The method of claim 45, wherein the indicated action comprises accessing a program that is similar to the program of interest.

55. The method of claim 45, wherein the program of interest is the same as the program that the user is watching.

56. The method of claim 45, wherein displaying the watch list comprises displaying only programs on the watch list that are currently available to the user.

57. The method of claim 45, wherein the watch list is displayed overlaid on the program being viewed by the user.

58. The method of claim 45, wherein the watch list is displayed on the same display device as the displayed program without obscuring the program that the user is watching.

59. The method of claim 45, wherein the watch list is displayed on a different display device than is being used to display the program that the user is watching.

60. The method of claim 59, wherein the watch list is displayed on a touch-screen remote control.

61. The method of claim 45, further comprising displaying the watch list automatically prior to the start of a program on the watch list.

62. The method of claim 61, further comprising allowing the user to highlight a program on the watch list, and simultaneously displaying the program that the user is watching, the watch list, and information related to the highlighted program.

63. The method of claim 62, wherein the information related to the highlighted program is video or a video image associated with the highlighted program.

64. The method of claim 62, wherein the information related to the highlighted program is a description of the highlighted program.

65. The method of claim 45, wherein the user indicates an action by pressing a corresponding key on a remote control.

66. The method of claim 45, wherein the user indicates an action by selecting an on-screen option.

67. The method of claim 66, wherein the on-screen option is displayed as part of the watch list and associated with a program on the watch list, and the watch list is displayed on the same device which is displaying the program that the user is watching.

68. The method of claim 66, wherein the on-screen option is displayed as part of the watch list and associated with a program on the watch list, and the watch list is displayed on a different device than the one which is displaying the program that the user is watching.

69. The method of claim 45, wherein the user indicates a default action by selecting a program from the watch list.

70. The method of claim 45, wherein the indicated action is watching the indicated program.

71. The method of claim 45, wherein the indicated action is listening to the indicated program.

72. The method of claim 45, wherein the indicated action is surfing the indicated program.

73. The method of claim 45, wherein the indicated action is displaying information about the indicated program.

74. The method of claim 45, wherein the indicated action is playing the indicated program.

75. The method of claim 45, wherein the indicated action is downloading the indicated program.

76. The method of claim 45, wherein the indicated action is viewing the indicated program.

77. The method of claim 45, wherein the indicated action is removing the indicated program from the watch list.

78. The method of claim 45, further comprising allowing the user to access programs on the watch list without displaying the watch list.

79. The method of claim 78, wherein allowing the user to access programs on the watch list comprises displaying a next program on the watch list when the user presses a corresponding key on a remote control.

80. The method of claim 78, wherein allowing the user to access programs on the watch list comprises displaying a previous program on the watch list when the user presses a corresponding key on a remote control.

81. The method of claim 45, further comprising adding a program to the watch list independent of the user action.

82. The method of claim 81, wherein the program is added to the watch list as a promotion.

83. The method of claim 45, further comprising automatically removing the program of interest from the watch list when the program is no longer available.

84. The method of claim 45, wherein the user input comprises pressing a key on a remote control.

85. The method of claim 45, wherein the user input comprises making a selection on a touch-screen remote control.

86. The method of claim 45, further comprising adding a program to the watch list after the user has watched the program for at least a specified period of time.

87. The method of claim 45, further comprising automatically removing the watch list from the display after a specified period of user inaction.

88. The method of claim 45, further comprising removing the watch list from the display in response to user input.

89. The method of claim 45, further comprising automatically pausing a first program that the user is watching when the user selects a second program from the watch list.

90. The method of claim 89, further comprising automatically restarting the first program that was paused when the user returns to the first program.

91. The method of claim 89, wherein the first program is a video-on-demand program.

92. The method of claim 89, wherein the first program is a previously recorded program.

93. The method of claim 89, wherein the first program is recorded as broadcast while paused.

94. The method of claim 93, further comprising automatically playing the recorded portion of the first program that was paused when the user returns to the first program.

95. The method of claim 45, further comprising automatically saving the state of a first program that the user is watching when the user selects a second program from the watch list.

96. The method of claim 95, further comprising automatically restoring the state of the first program when the user returns to the first program.

97. The method of claim 95, wherein the first program comprises a software application.

98. The method of claim 95, wherein the software application comprises an email application.

99. The method of claim 95, wherein the software application comprises an e-commerce application.

100. The method of claim 95, wherein the software application comprises a game.

101. The method of claim 45, further comprising allowing the user to specify the sort criteria for the programs on the watch list.

102. The method of claim 101, wherein the sort criteria comprise at least one of program start time, channel identifier, type of program, most recent time viewed, and program name.

103. A system that provides program access to a user with an interactive television application, comprising:
circuitry that adds a program of interest to a watch list based on at least one user action, that displays the watch list in response to user input while the user is watching a program, that allows the user to indicate a program on the displayed watch list, that allows the user to indicate an action to be performed that is related to the indicated program; and that performs the indicated action.

104. The system of claim 103, wherein the program of interest is one of a television program, a video-on-demand program, a near video-on-demand program, a previously recorded program, an Internet web page, a music channel, a digital audio program, a game, or a software application.

105. The system of claim 103, wherein the user action comprises selecting the program of interest in an interactive program guide.

106. The system of claim 103, wherein the user action comprises purchasing the program of interest.

107. The system of claim 103, wherein the user action comprises recording the program of interest.

108. The system of claim 103, wherein programs related to the program of interest are also added to the watch list.

109. The system of claim 108, wherein the programs related to the program of interest are episodes of the same program series.

110. The system of claim 103, wherein the user action comprises defining a preference profile.

111. The system of claim 110, further comprising automatically removing the program of interest from the watch list when the user changes the preference profile.

112. The system of claim 103, wherein the indicated action comprises accessing a program that is similar to the program of interest.

113. The system of claim 103, wherein the program of interest is the same as the program that the user is watching.

114. The system of claim 103, wherein displaying the watch list comprises displaying only programs on the watch list that are currently available to the user.

115. The system of claim 103, wherein the watch list is displayed overlaid on the program being viewed by the user.

116. The system of claim 103, wherein the watch list is displayed on the same display device as the displayed program without obscuring the program that the user is watching.

117. The system of claim 103, wherein the watch list is displayed on a different display device than is being used to display the program that the user is watching.

118. The system of claim 117, wherein the watch list is displayed on a touch-screen remote control.

119. The system of claim 103, further comprising displaying the watch list automatically prior to the start of a program on the watch list.

120. The system of claim 119, further comprising allowing the user to highlight a program on the watch list, and simultaneously displaying the program that the user is watching, the watch list, and information related to the highlighted program.

121. The system of claim 120, wherein the information related to the highlighted program is video or a video image associated with the highlighted program.

122. The system of claim 120, wherein the information related to the highlighted program is a description of the highlighted program.

123. The system of claim 103, wherein the user indicates an action by pressing a corresponding key on a remote control.

124. The system of claim 103, wherein the user indicates an action by selecting an on-screen option.

125. The system of claim 124, wherein the on-screen option is displayed as part of the watch list and associated with a program on the watch list, and the watch list is displayed on the same device which is displaying the program that the user is watching.

126. The system of claim 124, wherein the on-screen option is displayed as part of the watch list and associated with a program on the watch list, and the watch list is displayed on a different device than the one which is displaying the program that the user is watching.

127. The system of claim 103, wherein the user indicates a default action by selecting a program from the watch list.

128. The system of claim 103, wherein the indicated action is watching the indicated program.

129. The system of claim 103, wherein the indicated action is listening to the indicated program.

130. The system of claim 103, wherein the indicated action is surfing the indicated program.

131. The system of claim 103, wherein the indicated action is displaying information about the indicated program.

132. The system of claim 103, wherein the indicated action is playing the indicated program.

133. The system of claim 103, wherein the indicated action is downloading the indicated program.

134. The system of claim 103, wherein the indicated action is viewing the indicated program.

135. The system of claim 103, wherein the indicated action is removing the indicated program from the watch list.

136. The system of claim 103, further comprising allowing the user to access programs on the watch list without displaying the watch list.

137. The system of claim 136, wherein allowing the user to access programs on the watch list comprises displaying a next program on the watch list when the user presses a corresponding key on a remote control.

138. The system of claim 136, wherein allowing the user to access programs on the watch list comprises displaying a previous program on the watch list when the user presses a corresponding key on a remote control.

139. The system of claim 103, further comprising adding a program to the watch list independent of the user action.

140. The system of claim 139, wherein the program is added to the watch list as a promotion.

141. The system of claim 103, further comprising automatically removing the program of interest from the watch list when the program is no longer available.

142. The system of claim 103, wherein the user input comprises pressing a key on a remote control.

143. The system of claim 103, wherein the user input comprises making a selection on a touch-screen remote control.

144. The system of claim 103, further comprising adding a program to the watch list after the user has watched the program for at least a specified period of time.

145. The system of claim 103, further comprising automatically removing the watch list from the display after a specified period of user inaction.

146. The system of claim 103, further comprising removing the watch list from the display in response to user input.

147. The system of claim 103, further comprising automatically pausing a first program that the user is watching when the user selects a second program from the watch list.

148. The system of claim 147, further comprising automatically restarting the first program that was paused when the user returns to the first program.

149. The system of claim 147, wherein the first program is a video-on-demand program.

150. The system of claim 147, wherein the first program is a previously recorded program.

151. The system of claim 147, wherein the first program is recorded as broadcast while paused.

152. The system of claim 151, further comprising automatically playing the recorded portion of the first program that was paused when the user returns to the first program.

153. The system of claim 103, further comprising automatically saving the state of a first program that the user is watching when the user selects a second program from the watch list.

154. The system of claim 153, further comprising automatically restoring the state of the first program when the user returns to the first program.

155. The system of claim 153, wherein the first program comprises a software application.

156. The system of claim 155, wherein the software application comprises an email application.

157. The system of claim 155, wherein the software application comprises an e-commerce application.

158. The system of claim 155, wherein the software application comprises a game.

159. The system of claim 103, further comprising allowing the user to specify the sort criteria for the programs on the watch list.

160. The system of claim 159, wherein the sort criteria comprise at least one of program start time, channel identifier, type of program, most recent time viewed, and program name.
